(19) United States
(12) Patent Application Publication
(10) Pub. No.: US 2020/0255968 A1
(43) Pub. Date: Aug. 13, 2020

(54) SUBSTRATE-HOLDER INSPECTION APPARATUS, PLATING APPARATUS INCLUDING THE SAME, AND APPEARANCE INSPECTION APPARATUS

(71) Applicant: EBARA CORPORATION, Tokyo (JP)

(72) Inventors: Yoshitaka MUKAIYAMA, Tokyo (JP); Toshio YOKOYAMA, Tokyo (JP); Kunio OISHI, Tokyo (JP); Masaaki KIMURA, Tokyo (JP); Jumpei FUJIKATA, Tokyo (JP)

(21) Appl. No.: 16/315,096

(22) PCT Filed: Jun. 7, 2017
(86) PCT No.: PCT/JP2017/022028

§ 371 Date: Jan. 3, 2019

(30) Foreign Application Priority Data
Jul. 4, 2016 (JP) 2016-132453

(51) Int. Cl. C25D 17/06; C25D 17/00; C25D 21/12; G01N 21/88

(52) U.S. Cl. CPC C25D 17/06; C25D 17/005; G01N 21/88; C25D 21/12; C25D 17/004

(57) ABSTRACT

An inspection apparatus, a plating apparatus, and an appearance inspection apparatus that are capable of automatically inspecting a substrate holder are provided. An inspection apparatus that includes an electric contact configured to contact a substrate to allow current flow to the substrate and a sealing member configured to seal a surface of the substrate and that inspects a substrate holder holding the substrate is provided. The inspection apparatus includes a stocker installation part in which a stocker configured to house the substrate holder is installed, a cleaning device configured to cleanse the substrate holder, a substrate attaching/detaching device configured to open and close the substrate holder, an appearance inspection apparatus configured to acquire image data or shape data of appearance of at least one of the sealing member and the electric contact, and a conveyer configured to convey the substrate holder among the stocker, the cleaning device, and the appearance inspection apparatus.

### TECHNICAL FIELD

The present invention relates to a substrate-holder inspection apparatus, a plating apparatus including the same, and an appearance inspection apparatus.

### BACKGROUND ART

In a conventionally known apparatus, a substrate held by a substrate holder is vertically inserted into a plating bath containing plating solution and is provided with electrolytic plating (refer to Japanese Patent No. 3979847, for example). The substrate holder used in such a plating apparatus seals the surface of the substrate to form an internal space into which no plating solution flows. The substrate holder includes, in the internal space, an electric contact configured to contact the surface of the substrate to allow current flow to the substrate.

Such a substrate holder plays an extremely important role in plating processing. Specifically, when the electric contact of the substrate holder appropriately contacts the surface of the substrate, appropriate current flows to the substrate to form a uniform plated film on the substrate. The appropriate sealing of the surface of the substrate by the substrate holder prevents the plating solution from flowing into the internal space, thereby suppressing, for example, corrosion of the electric contact when being in contact with the plating solution. In other words, for example, when the electric contact is broken or corroded, current cannot appropriately flow to the substrate. In addition, for example, when a defect occurs to a sealing member of the substrate holder, the plating solution flows into the internal space. Thus, inspection of whether a defect occurs to the substrate holder is important work for continuation of appropriate plating processing.

### SUMMARY OF INVENTION

Conventionally, whether a defect occurs to the substrate holder has not been determined by an established quantitative method, but has been visually inspected by a worker. However, this visual inspection of a defect of the substrate holder by the worker has some disadvantageous. Specifically, the criterion of the defect determination differs between workers, which potentially leads to overlook of a defect and results in a scrap substrate. Moreover, the inspection takes time, which leads to a reduced plating production rate. In addition, a component (substrate pressing part) of the substrate holder needs to be removed to inspect a defect of the substrate holder, which potentially causes mix-up of components.

When inspecting a defect of the substrate holder, a worker needs to insert and remove the substrate holder into and from a bath (stocker) that houses the substrate holder. However, the recent substrate holder has a larger size along with increase in substrate size. Such a substrate holder weighs, for example, 8 kg approximately, and thus the worker is potentially injured when handling the substrate holder. Since the substrate holder is heavy, the substrate holder potentially contacts the stocker due to mishandling when the worker inserts and removes the substrate holder into and from the stocker. Since the substrate holder extremely largely affects plating processing as described above, any impact on the substrate holder potentially hinders appropriate execution of the plating processing.

An increasing number of substrate holders are used in a plating apparatus due to recent improvement of the productivity of plating apparatuses. Accordingly, the inspection needs to be performed on a significantly large number of substrate holders. Thus, when the substrate holders are subjected to defect inspection by a plurality of workers, wrong determination occurs at a higher probability in the inspection.

The present invention is intended to solve the above-described problem and provide an inspection apparatus, a plating apparatus, and an appearance inspection apparatus that are capable of automatically inspecting a substrate holder.

In an aspect of the present invention, an inspection apparatus is provided that includes an electric contact configured to contact a substrate to allow current flow to the substrate and a sealing member configured to seal a surface of the substrate and that inspects a substrate holder holding the substrate. The inspection apparatus includes a stocker installation part in which a stocker configured to house the substrate holder is installed, a cleaning device configured to cleanse the substrate holder, a substrate attaching/detaching device configured to open and close the substrate holder, an appearance inspection apparatus configured to acquire image data or shape data of appearance of at least one of the sealing member and the electric contact, and a conveyer configured to convey the substrate holder among the stocker, the cleaning device, and the appearance inspection apparatus.

According to this aspect, the conveyer can take the substrate holder out of the stocker installed in the stocker installation part and convey the substrate holder to the substrate attaching/detaching device. The substrate attaching/detaching device can open and close the substrate holder, and the appearance inspection apparatus can automatically perform inspection. The cleaning device can cleanse the substrate holder as necessary. Thus, the inspection and cleansing of the substrate holder can be automatically performed. The appearance inspection apparatus can inspect the appearance of the sealing member or the electric contact. Specifically, the appearance inspection apparatus can acquire image data or shape data of any of the sealing member and the electric contact, and thus it is possible to inspect whether a defect occurs to the appearance of any of the sealing member and the electric contact by comparing the acquired image data or shape data with image data or shape data of the corresponding one of a non-defective sealing member and a non-defective electric contact.

In another aspect of the present invention, the substrate holder includes a first holding member including a surface on which the substrate is placed, and a second holding member including the sealing member and the electric contact and configured to detachably hold the substrate together with the first holding member. The substrate attaching/detaching device is configured to maintain such a state that the second holding member is removed from the first holding member. The appearance inspection apparatus includes a measuring device configured to acquire image data or shape data of the appearance of at least one of the sealing member and the electric contact, and an arm unit configured to move the measuring device to a position between the first holding member and the second holding member.

According to this aspect, the measuring device can be disposed between the first holding member and the second holding member to acquire image data or shape data of the appearance of any of the sealing member and the electric contact. Since the electric contact and the sealing member contact the substrate, parts of the electric contact and the sealing member, which contact the substrate, are positioned on a side of the second holding member, which faces to the first holding member. Thus, according to this aspect, image data or shape data of the parts of the electric contact and the sealing member, which contact the substrate, can be acquired.

In another aspect of the present invention, the second holding member of the substrate holder includes a relay contact portion configured to contact the electric contact to supply current from an external power source to the electric contact, and the appearance inspection apparatus is configured to acquire image data or shape data of appearance of the relay contact portion.

According to this aspect, the appearance inspection apparatus can acquire image data or shape data of the appearance of the relay contact portion. It is possible to inspect whether a defect occurs to the appearance of the relay contact portion by comparing the acquired image data or shape data with image data or shape data of a non-defective relay contact portion.

In another aspect of the present invention, the substrate holder includes an external contact portion electrically connected with an external power source to supply current from the external power source to the electric contact, and the appearance inspection apparatus is configured to acquire image data or shape data of appearance of the external contact portion.

According to this aspect, the appearance inspection apparatus can acquire image data or shape data of the appearance of the external contact portion. It is possible to inspect whether a defect occurs to the appearance of the external contact portion by comparing the acquired image data or shape data with image data or shape data of a non-defective external contact portion.

In another aspect of the present invention, the inspection apparatus further includes a substrate conveyance device configured to convey a dummy substrate to the substrate attaching/detaching device, and a conduction check device configured to check conduction between the electric contact and the dummy substrate when the substrate attaching/detaching device takes in the substrate holder holding the dummy substrate.

According to this aspect, the inspection apparatus can check the conduction between the electric contact and the dummy substrate. The dummy substrate is a substrate in which a conductive film formed on the surface thereof has a more precisely controlled thickness than that of a product substrate. In other words, the dummy substrate is a substrate for calibration in which the conductive film is controlled to have a desired thickness. Thus, the resistivity of the surface of the dummy substrate is precisely controlled by precisely controlling the thickness of the conductive film.

In another aspect of the present invention, the inspection apparatus includes a substrate conveyance device configured to convey a dummy substrate to the substrate attaching/detaching device, and a leakage check device configured to inspect whether the sealing member appropriately seals a surface of the dummy substrate when the substrate attaching/detaching device takes in the substrate holder holding the dummy substrate.

According to this aspect, the inspection apparatus can check whether the sealing member of the substrate holder appropriately seals the dummy substrate. The dummy substrate is a substrate in which a film formed on the surface thereof has a more precisely controlled thickness than that of a product substrate. In other words, the dummy substrate is a substrate for calibration in which the conductive film is controlled to have a desired thickness.

In another aspect of the present invention, the inspection apparatus includes a control device configured to control the conveyer, the substrate attaching/detaching device, the appearance inspection apparatus, and the cleaning device. The control device causes the cleaning device to cleanse the substrate holder before inspection by the appearance inspection apparatus.

According to this aspect, the substrate holder as an inspection target can be cleansed once before the inspection apparatus inspects the cleansed substrate holder.

In another aspect of the present invention, the inspection apparatus includes a control device configured to control the conveyer, the substrate attaching/detaching device, the appearance inspection apparatus, and the cleaning device. The control device causes the cleaning device to cleanse the substrate holder when inspection by the appearance inspection apparatus determines that the substrate holder is defective.

According to this aspect, the inspection apparatus can automatically cleanse the substrate holder when it is determined that a defect has occurred to the substrate holder. When the defect of the substrate holder is attributable to contamination of the substrate holder, the substrate holder can be made non-defective by cleansing.

In another aspect of the present invention, the control device causes the appearance inspection apparatus to inspect the substrate holder again after the inspection by the appearance inspection apparatus has determined that the substrate holder is defective and the cleaning device has cleansed the substrate holder.

According to this aspect, after cleansing the substrate holder to which it is determined that a defect has occurred, the inspection apparatus can inspect the substrate holder again at the appearance inspection apparatus. Accordingly, it is possible to check whether the substrate holder has become non-defective by the cleansing.

In another aspect of the present invention, the inspection apparatus is coupled with a plating apparatus configured to perform plating processing on the substrate by using the substrate holder, and the stocker is movable between the plating apparatus and the stocker installation part of the inspection apparatus.

According to this aspect, it is possible to easily move a stocker housing a substrate holder to be inspected from the plating apparatus to the inspection apparatus, and easily move a stocker housing an inspected substrate holder from the inspection apparatus to the plating apparatus. It is also possible to move a stocker housing a substrate holder to be inspected to the inspection apparatus, and simultaneously move, to the plating apparatus, a stocker disposed in the inspection apparatus and housing an inspected non-defective substrate holder. Accordingly, the number of substrate holders usable by the plating apparatus is maintained while any substrate holder is being inspected by the inspection apparatus, thereby preventing decrease in the productivity of the plating apparatus.

In another aspect of the present invention, a plating apparatus is provided that is configured to perform plating processing on the substrate by using the substrate holder. The plating apparatus includes any one of the above-described inspection apparatuses.

In another aspect of the present invention, an appearance inspection apparatus is provided that includes an electric contact configured to contact a substrate to allow current flow to the substrate and a sealing member configured to seal a surface of the substrate and that inspects appearance of a substrate holder holding the substrate. The appearance inspection apparatus is configured to acquire image data or shape data of appearance of at least one of the sealing member and the electric contact and determine whether appearance of the substrate holder is non-defective.

According to this aspect, the appearance of the sealing member or the electric contact of the substrate holder can be automatically inspected. Specifically, image data or shape data of any of the sealing member and the electric contact can be acquired, and thus it is possible to inspect whether a defect occurs to the appearance of the sealing member or the electric contact by comparing the acquired image data or shape data with, for example, image data or shape data of the corresponding one of a non-defective sealing member and a non-defective electric contact.

### BRIEF DESCRIPTION OF DRAWINGS

FIG. 1 is a schematic entire arrangement diagram of an inspection apparatus according to a first embodiment;

FIG. 2 is an exploded perspective view of a substrate holder;

FIG. 3 is an enlarged view of an external contact portion;

FIG. 4 is an enlarged partial cross-sectional view of the substrate holder;

FIG. 5 is a schematic side view of a fixing unit;

FIG. 6 is a schematic side cross-sectional view illustrating an exemplary appearance inspection apparatus configured to inspect the appearance of the substrate holder;

FIG. 7 is a schematic side cross-sectional view illustrating another exemplary appearance inspection apparatus configured to inspect the appearance of the substrate holder;

FIG. 8 is a schematic top view illustrating the entire configuration of a cleaning device;

FIG. 9 is a schematic side cross-sectional view illustrating a substrate-holder cleansing bath included in the cleaning device;

FIG. 10 is a schematic side cross-sectional view illustrating a substrate-holder drying bath included in the cleaning device;

FIG. 11A is a schematic side view of a substrate conveyance mechanism;

FIG. 11B is a schematic top view of the substrate conveyance mechanism;

FIG. 12 illustrates an exemplary menu screen displayed on a display unit included in a control device illustrated in FIG. 1;

FIG. 13 is a flowchart illustrating an exemplary inspection method using the inspection apparatus according to the present embodiment;

FIG. 14 is a flowchart illustrating another exemplary inspection method using the inspection apparatus according to the present embodiment; and

FIG. 15 is a schematic entire arrangement diagram of the inspection apparatus according to a second embodiment.

### DESCRIPTION OF EMBODIMENTS

### First Embodiment

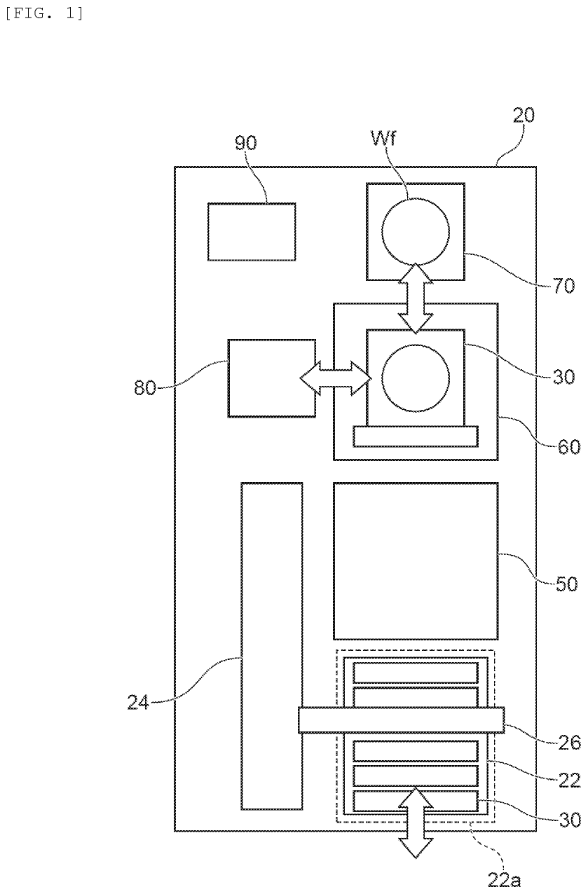

The following describes a first embodiment of the present invention with reference to the accompanying drawings. In the drawings described below, any identical or corresponding components are denoted by an identical reference sign, and duplicate description thereof will be omitted. FIG. 1 is a schematic entire arrangement diagram of an inspection apparatus according to the first embodiment. As illustrated in FIG. 1, this inspection apparatus 20 includes a stocker 22 configured to house at least one substrate holder 30, a cleaning device 50 for cleansing the substrate holder 30, and a fixing unit 60 (corresponding to an exemplary substrate attaching/detaching device) configured to open and close the substrate holder 30 and attach and detach a substrate Wf to and from the substrate holder 30. The stocker 22, the cleaning device 50, and the fixing unit 60 are disposed in this order in the inspection apparatus 20. The substrate Wf may be, for example, a dummy substrate for inspection. The dummy substrate is a substrate in which a conductive film formed on the surface thereof has a more precisely controlled thickness than that of a product substrate. In other words, the dummy substrate is a substrate for calibration in which the conductive film is controlled to have a desired thickness.

The inspection apparatus 20 further includes a transporter 24 (corresponding to an exemplary conveyer) configured to convey the substrate holder 30 among the stocker 22, the cleaning device 50, and the fixing unit 60. The transporter 24 is positioned on sides of the stocker 22, the cleaning device 50, and the fixing unit 60.

An appearance inspection apparatus 80 and a substrate conveyance device 70 are disposed near the fixing unit 60. The appearance inspection apparatus 80 is configured to inspect whether the appearance of the substrate holder 30 disposed on the fixing unit 60 is non-defective. The substrate conveyance device 70 is configured to convey the substrate Wf for conduction check to the substrate holder 30.

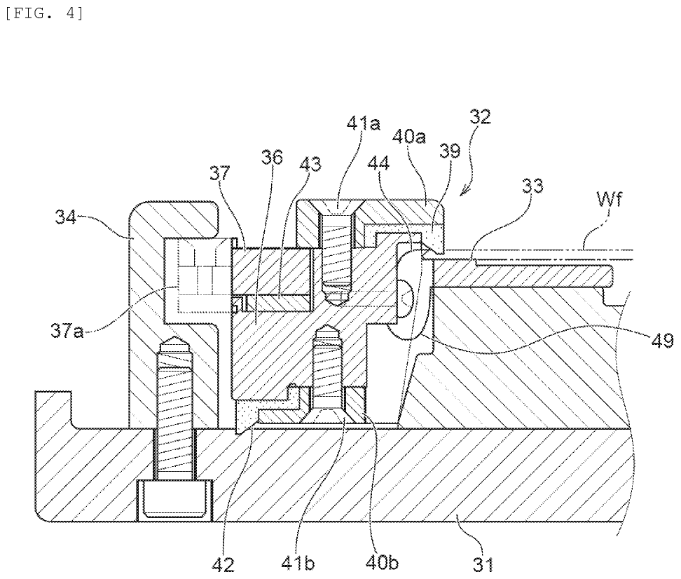

Although not illustrated, the fixing unit 60 includes a leakage check device and a conduction check device. The leakage check device is configured to inspect whether a sealing member (refer to FIG. 4) of the substrate holder 30 disposed on the fixing unit 60 appropriately seals the surface of the substrate (in other words, whether the substrate holder 30 is in a non-defective state in which no leakage occurs through the sealing member when the substrate holder 30 is immersed in solution while holding the substrate). The conduction check device is configured to check conduction between an electric contact (refer to FIG. 4) and the substrate Wf. The leakage check device may be, for example, a leakage inspection mechanism disclosed in Japanese Patent No. 5782398 or a leakage inspection mechanism disclosed in the publication of Japanese Patent No. 2015-63761. The entire contents of these literatures are incorporated in the present specification by reference. The conduction check device may be, for example, a conduction check mechanism disclosed in Japanese Patent No. 4067275. The entire contents of this literature are incorporated in the present specification by reference.

The stocker 22 is movable inside and outside the inspection apparatus 20. The stocker 22 may be, for example, a wagon including a caster disclosed in Japanese Patent No. 5642517. The entire contents of this literature are incorporated in the present specification by reference. The inspection apparatus 20 includes a position sensor (not illustrated) configured to detect the position of the stocker 22. This configuration allows detection of whether the stocker 22 conveyed into the inspection apparatus 20 is at a normal position. In the present embodiment, a stocker installation part 22a refers to a region in which the stocker 22 is installed inside the inspection apparatus 20. The stocker installation part 22a may be simply a region saved for installation of the stocker 22 or a space defined by, for example, a frame member for housing the stocker 22. In the present embodiment, the stocker 22 is configured to travel between a plating apparatus (not illustrated) and the stocker installation part 22a of the inspection apparatus 20. When being disposed in the plating apparatus, the stocker 22 houses the substrate holder 30 used at the plating apparatus. The stocker 22 housing the substrate holder 30 is conveyed into the inspection apparatus 20 for inspection of the state of the substrate holder 30 by the inspection apparatus 20.

The transporter 24 includes an arm unit 26 configured to hold the substrate holder 30. The transporter 24 takes the substrate holder 30 out of the stocker 22 and conveys the substrate holder 30 to the cleaning device 50 or the fixing unit 60. In the example illustrated in FIG. 1, the substrate holder 30 is vertically housed in the stocker 22. In this configuration, the transporter 24 rotates the arm unit 26 holding the substrate holder 30 by 90° approximately to horizontally hold the substrate holder 30 and place the substrate holder 30 in the fixing unit 60.

The inspection apparatus 20 further includes a control device 90 configured to control the transporter 24, the fixing unit 60, the appearance inspection apparatus 80, the leakage check device, the conduction check device, and the cleaning device 50 through communication. The control device 90 includes a display unit such as a display (not illustrated) and can display, for example, settings of the inspection apparatus 20.

In the inspection apparatus 20 according to the present embodiment, the fixing unit 60 is provided adjacent to the cleaning device 50, the appearance inspection apparatus 80, and the substrate conveyance device 70. The transporter 24 is disposed at such a position that the transporter 24 can convey the substrate holder 30 between the fixing unit 60 and the stocker 22. Since the units of the inspection apparatus 20 according to the present embodiment are disposed in this manner, a series of inspections can be continuously performed on the substrate holder 30 in a significantly short time.

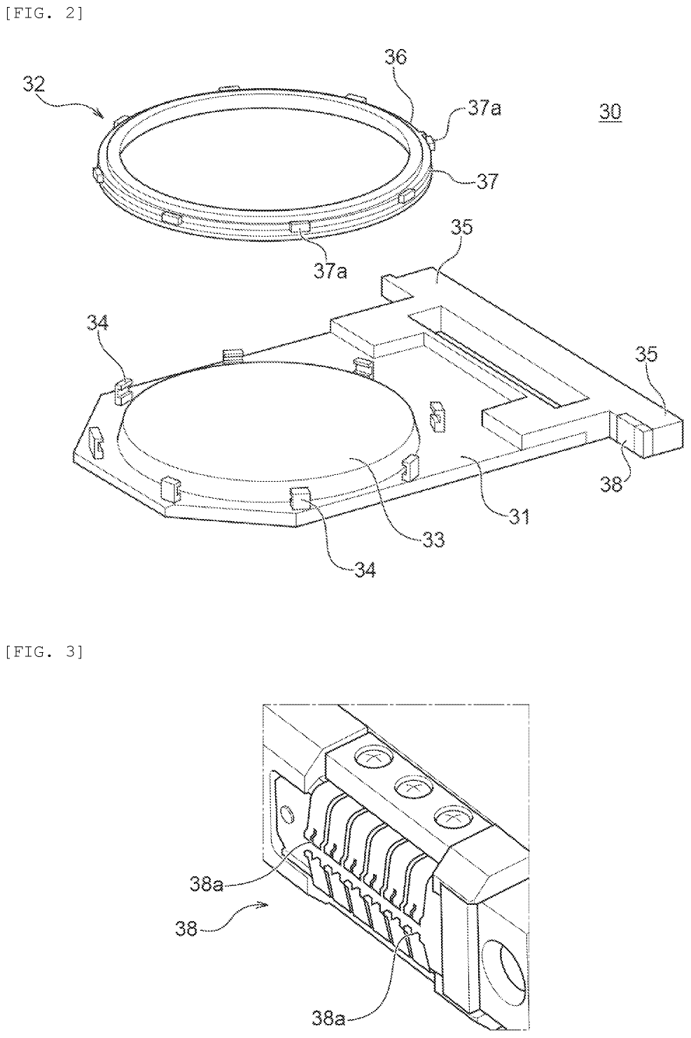

The following describes each component illustrated in FIG. 1 in detail. FIG. 2 is an exploded perspective view of the substrate holder 30. As illustrated in FIG. 2, the substrate holder 30 includes a first holding member 31 made of, for example, vinyl chloride and shaped in a rectangular plate, and a second holding member 32 detachably provided to the first holding member 31. A placement surface 33 on which the substrate Wf is placed is provided substantially at the center of the first holding member 31 of the substrate holder 30. A plurality of clampers 34 each including an inward protrusion and having an inverted L shape are provided at equal intervals outside the placement surface 33 of the first holding member 31 along the circumference of the placement surface 33.

A pair of substantially T-shaped hands 35 are coupled at an end part of the first holding member 31 of the substrate holder 30. Each hand 35 serves as a support when the substrate holder 30 is conveyed or suspended. In the stocker 22 illustrated in FIG. 1, when the hands 35 are hooked on the upper surface of a peripheral wall of the stocker 22, the substrate holder 30 is vertically suspended. The hands 35 of the substrate holder 30 thus suspended are held by the arm unit 26 of the transporter 24 when the substrate holder 30 is conveyed.

An external contact portion 38 is provided to one of the hands 35 to be electrically connected with an external power source. The external contact portion 38 is electrically connected with a plurality of relay contact portions (refer to FIG. 4) provided on the circumference of the placement surface 33 through a plurality of wires. The external contact portion 38 includes a plurality of contact portions 38a as illustrated in FIG. 3.

The second holding member 32 includes a ring sealing holder 36. A press ring 37 for fixing the sealing holder 36 to the first holding member 31 by pressing is rotatably mounted on the sealing holder 36 of the second holding member 32. The press ring 37 includes a plurality of outward protrusions 37a on the outer periphery thereof. The upper surface of each protrusion 37a and the lower surface of the inward protrusion of each clamper 34 include tapered surfaces tilted in rotational directions opposite to each other.

To hold the substrate, first, the substrate Wf is placed on the placement surface 33 of the first holding member 31 while the second holding member 32 is removed from the first holding member 31, and then the second holding member 32 is attached to the first holding member 31. Subsequently, the press ring 37 is rotated clockwise to slip the protrusion 37a of the press ring 37 into (below) the inward protrusion of the clamper 34. Accordingly, the first holding member 31 and the second holding member 32 are clamped and locked to each other through the tapered surfaces provided to the press ring 37 and the clamper 34, and thus the substrate Wf is held. To cancel the holding of the substrate Wf, the press ring 37 is rotated anticlockwise while the first holding member 31 and the second holding member 32 are locked to each other. Accordingly, the protrusion 37a of the press ring 37 is removed from the inverted L-shaped clamper 34 to cancel the holding of the substrate Wf.

FIG. 4 is an enlarged partial cross-sectional view of the substrate holder 30. As illustrated in FIG. 4, the second holding member 32 includes a substrate sealing member 39 (corresponding to an exemplary sealing member), and a first fixing ring 40a that fixes the substrate sealing member 39 to the sealing holder 36. The first fixing ring 40a is attached to the sealing holder 36 through a fastener 41a such as a screw. The second holding member 32 includes a holder sealing member 42, and a second fixing ring 40b that fixes the holder sealing member 42 to the sealing holder 36. The second fixing ring 40b is attached to the sealing holder 36 through a fastener 41b such as a screw.

The sealing holder 36 is provided with a stepped portion at the outer periphery thereof. The press ring 37 is rotatably mounted on the stepped portion through a spacer 43. The mounted press ring 37 is prevented from escaping by the outer periphery of the first fixing ring 40a.

When the second holding member 32 is locked to the first holding member 31, the substrate sealing member 39 is made contact with an outer peripheral part of the surface of the substrate Wf by pressing. The substrate sealing member 39 is uniformly pressed to the substrate Wf to seal a gap between the outer peripheral part of the surface of the substrate Wf and the second holding member 32. Similarly, when the second holding member 32 is locked to the first holding member 31, the holder sealing member 42 is made contact with the surface of the first holding member 31 by pressing. The holder sealing member 42 is uniformly pressed to the first holding member 31 to seal a gap between the first holding member 31 and the second holding member 32.

As illustrated in FIG. 4, the second holding member 32 includes an electric contact 44 configured to contact the peripheral part of the substrate Wf to allow current flow to the substrate Wf. A plurality of the electric contacts 44 are provided along the inner periphery of the sealing holder 36. The first holding member 31 further includes a relay contact portion 49 configured to contact the electric contact 44 to supply current from the external power source to the electric contact 44 while the second holding member 32 is being attached to the first holding member 31. A plurality of the relay contact portions 49 are provided along the circumference of the placement surface 33. The relay contact portion 49 conducts with the external contact portion 38. Accordingly, current supplied from the external power source is supplied to the surface of the substrate Wf through the external contact portion 38, the relay contact portion 49, and the electric contact 44.

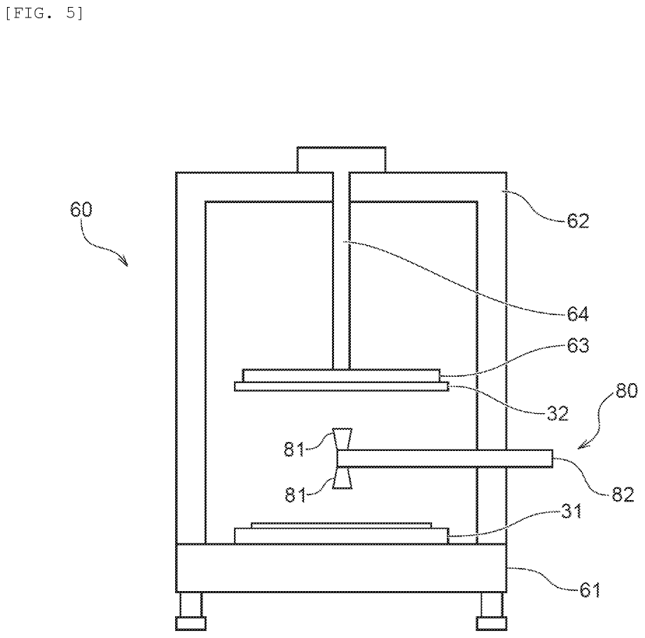

The following describes the configuration of the fixing unit 60 illustrated in FIG. 2. FIG. 5 is a schematic side view of the fixing unit 60. The fixing unit 60 includes a base 61 on which the first holding member 31 is placed, a frame 62, an arm 63 configured to attach and detach the second holding member 32 to and from the first holding member 31 while holding the second holding member 32, and an actuator 64 configured to vertically move the arm 63. The actuator 64 is fixed to the frame 62 and configured not only to move the arm 63 in the vertical direction but also to rotate the arm 63 in the circumferential direction.

When conveyed to the fixing unit 60 by the transporter 24 illustrated in FIG. 1, the substrate holder 30 is horizontally placed on the base 61. The actuator 64 moves down the arm 63, and the arm 63 holds the second holding member 32. The actuator 64 rotates the arm 63 holding the second holding member 32 in the circumferential direction to cancel the lock between the second holding member 32 and the first holding member 31. Thereafter, as illustrated in FIG. 5, the actuator 64 maintains the arm 63 in a state in which the second holding member 32 is unlocked and removed.

The fixing unit 60 is configured to remove the second holding member 32 from the first holding member 31 when the appearance inspection apparatus 80 illustrated in FIG. 1 inspects the appearance of the substrate holder 30. Specifically, the fixing unit 60 maintains such a state that the second holding member 32 is removed from the first holding member 31 while the substrate sealing member 39, the holder sealing member 42, and the electric contact 44 of the second holding member 32 illustrated in FIG. 4 face to the relay contact portion 49 of the first holding member 31. Subsequently, as illustrated in FIG. 5, while the second holding member 32 is being removed from the first holding member 31 by the fixing unit 60, the appearance inspection apparatus 80 places a measuring device 81 between the first holding member 31 and the second holding member 32. The appearance inspection apparatus 80 includes a moving arm 82 configured to horizontally move the measuring apparatus 81. Specifically, the appearance inspection apparatus 80 is configured to move close to the fixing unit 60 to insert the moving arm 82 into the fixing unit 60 through an opening (not illustrated) provided to a side surface of the fixing unit 60. The appearance inspection apparatus 80 may include a shaft (not illustrated) supporting the moving arm 82, and a body (not illustrated) supporting the shaft. Data of signal information measured by the measuring device 81 is transmitted from a communication unit (not illustrated) of the measuring device 81 to a control unit (not illustrated) including a signal receiving unit in a wired or wireless manner.

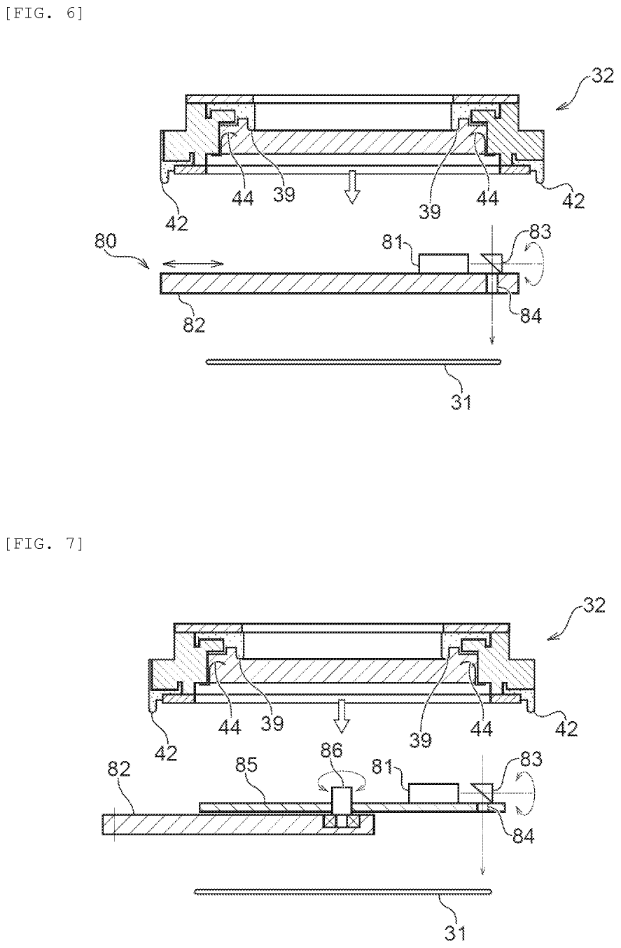

FIG. 6 is a schematic side cross-sectional view illustrating an exemplary appearance inspection apparatus 80 configured to inspect the appearance of the substrate holder 30. FIG. 7 is a schematic side cross-sectional view illustrating another exemplary appearance inspection apparatus 80 configured to inspect the appearance of the substrate holder 30. The exemplary appearance inspection apparatus 80 illustrated in FIG. 6 includes the measuring device 81 and a mirror 83 near a leading end of the moving arm 82. The measuring device 81 is an image capturing apparatus such as a camera configured to acquire image data of the appearance of the substrate holder 30, or a shape measuring device configured to acquire shape data of the appearance of the substrate holder 30. When the measuring device 81 is a shape measuring device, the measuring device 81 irradiates a target with laser such as blue laser to acquire shape data.

The measuring device 81 acquires image data or shape data of the appearance of the substrate sealing member 39, the holder sealing member 42, and the electric contact 44 of the second holding member 32 through the mirror 83. The moving arm 82 includes a hole 84. The measuring device 81 can also acquire image data or shape data of the appearance of the relay contact portion 49 (refer to FIG. 4) of the first holding member 31 through the hole 84 by rotating the mirror 83. The measuring device 81 can also acquire image data or shape data of the appearance of the external contact portion 38 of the first holding member 31 illustrated in FIG. 3 by moving the moving arm 82 and rotating the mirror 83. When the measuring device 81 itself is movable or rotatable, the mirror 83 does not need to be provided.

The appearance inspection apparatus 80 includes a control unit and a memory (not illustrated). Image data or shape data measured by the measuring device 81 is transmitted to the control unit. The control unit includes a display unit (not illustrated) configured to display a condition setting screen for setting a measurement condition, an input unit (not illustrated) through which a measurement condition is input, and a reading unit (not illustrated) for reading a computer program from a memory including a computer-readable recording medium. The memory stores, in advance, image data or shape data of the appearance of the substrate sealing member 39, the holder sealing member 42, the electric contact 44, the relay contact portion 49, and the external contact portion 38 of a non-defective substrate holder 30. The memory also records a computer program configured to cause the appearance inspection apparatus 80 to execute a series of appearance inspection processing. The control unit reads the computer program through the reading unit to determine any defect of the substrate holder 30 by comparing the image data or shape data measured by the measuring device 81 with the corresponding image data or shape data stored in the memory. Specifically, the control unit determines, for example, whether bending, break, or corrosion occurs to the electric contact 44, the relay contact portion 49, and the external contact portion 38, whether any flaw occurs to the substrate sealing member 39 and the holder sealing member 42, and whether plating solution flows (is leaked) into an internal space of the substrate holder 30. A result of the determination on the substrate holder 30 is transmitted to the control device 90 illustrated in FIG. 1. The recording medium included in the memory may be, for example, a CD-ROM, a DVD, a hard disk, a compact disk, a flash memory, a flexible disk, or a memory card.

In the appearance inspection apparatus 80 illustrated in FIG. 6, the moving arm 82 is movable in the XY direction (horizontal direction). With this configuration, the measuring device 81 attached to the moving arm 82 can be horizontally moved along the substrate sealing member 39, the holder sealing member 42, and the electric contact 44 of the second holding member 32, and the relay contact portion 49 of the first holding member 31.

The other exemplary appearance inspection apparatus 80 illustrated in FIG. 7 differs from the appearance inspection apparatus 80 illustrated in FIG. 6 in a movement mechanism of the measuring device 81. Specifically, in the appearance inspection apparatus 80 illustrated in FIG. 7, a vertically extending rotational shaft 86 is provided at one end of the moving arm 82. The rotational shaft 86 is provided with a horizontally extending rotational arm 85. The measuring device 81 and the mirror 83 are provided near a leading end of the rotational arm 85. The rotational arm 85 is configured to rotate about the rotational shaft 86. With this configuration, the measuring device 81 attached to the rotational arm 85 can rotate along the substrate sealing member 39, the holder sealing member 42, and the electric contact 44 of the second holding member 32, and the relay contact portion 49 of the first holding member 31.

In the present embodiment, the fixing unit 60 is configured to open and close the substrate holder 30 by attaching/detaching the second holding member 32 to and from the first holding member 31 through separation. However, the present invention is not limited thereto. When the first holding member 31 and the second holding member 32 of the substrate holder 30 are connected with each other through a hinge, the fixing unit 60 can adjust the degree of opening of the second holding member 32 relative to the first holding member 31. In this case, the appearance inspection apparatus 80 can acquire image data or shape data of the appearance of the substrate sealing member 39, the holder sealing member 42, and the electric contact 44 being exposed while the first holding member 31 is opened by the fixing unit 60.

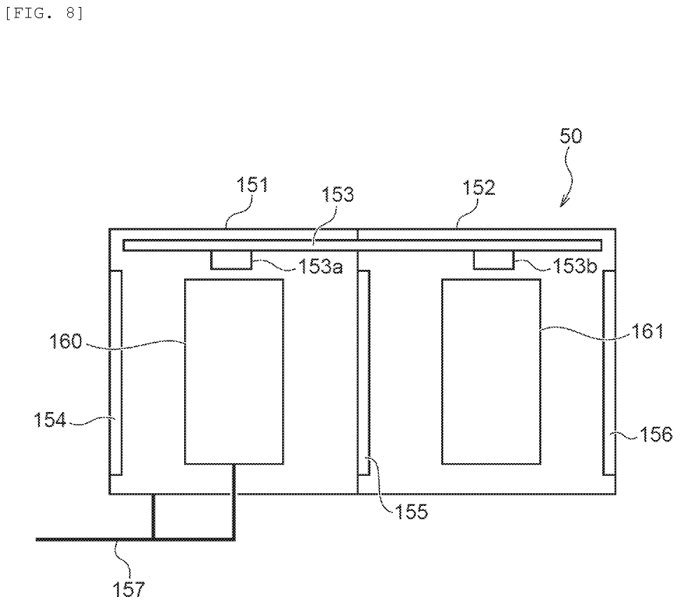

The following describes the cleaning device 50 illustrated in FIG. 1. FIG. 8 is a schematic top view illustrating the entire configuration of the cleaning device 50. As illustrated in FIG. 8, the cleaning device 50 includes a cleansing chamber 151, a substrate-holder cleansing bath 160 disposed in the cleansing chamber 151, a drying chamber 152, and a substrate-holder drying bath 161 disposed in the drying chamber 152. The cleaning device 50 further includes a substrate-holder conveying unit 153 disposed across the cleansing chamber 151 and the drying chamber 152. The substrate-holder conveying unit 153 includes a first hand 153a configured to hold and convey the substrate holder 30 in the cleansing chamber 151, and a second hand 153b configured to hold and convey the substrate holder 30 in the drying chamber 152. The substrate-holder conveying unit 153 is configured to convey the substrate holder 30 between the substrate-holder cleansing bath 160 and the substrate-holder drying bath 161.

The cleaning device 50 further includes a first opening and closing unit 154 that partitions the cleansing chamber 151 from the outside, a second opening and closing unit 155 that partitions the cleansing chamber 151 from the drying chamber 152, and a third opening and closing unit 156 that partitions the drying chamber 152 from the outside. The first opening and closing unit 154, the second opening and closing unit 155, and the third opening and closing unit 156 each include, for example, a shutter mechanism and is configured to freely open and close. The cleaning device 50 includes a drain pipe 157 for discharging, from the substrate-holder cleansing bath 160 and the cleansing chamber 151, cleansing liquid used in cleansing.

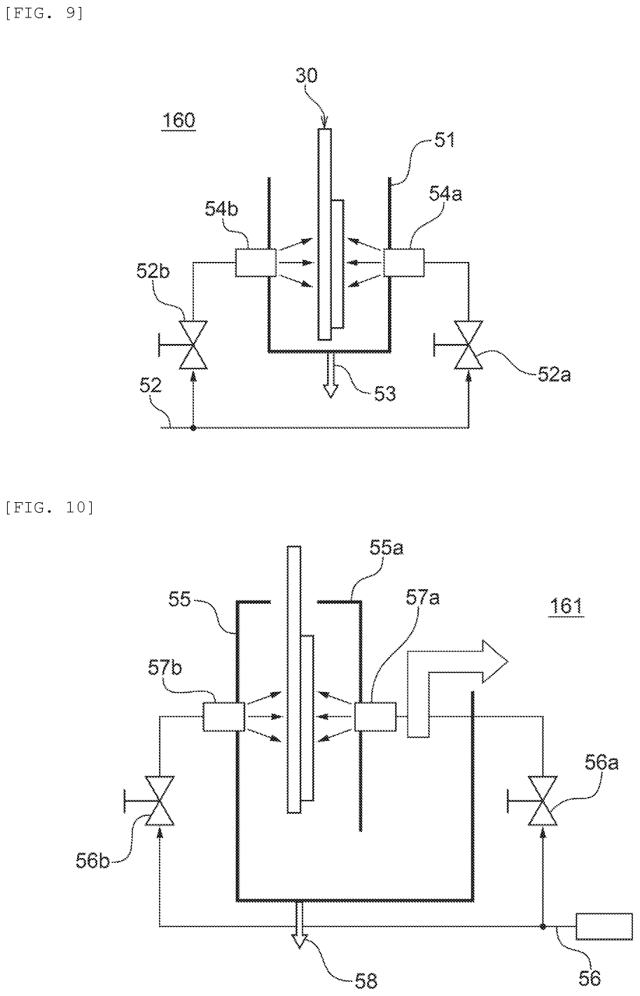

FIG. 9 is a schematic side cross-sectional view illustrating the substrate-holder cleansing bath 160 included in the cleaning device 50. FIG. 10 is a schematic side cross-sectional view illustrating the substrate-holder drying bath 161 included in the cleaning device 50. As illustrated in FIG. 9, the substrate-holder cleansing bath 160 includes a cleansing bath body 51 housing the substrate holder 30, a cleansing-liquid supply line 52 for supplying cleansing liquid such as pure water to the substrate holder 30, and a pair of nozzles 54a and 54b for spraying the cleansing liquid onto the substrate holder 30. The nozzles 54a and 54b are provided to the cleansing bath body 51 while facing to each other to spray the cleansing liquid onto both surfaces of the substrate holder 30. The cleansing-liquid supply line 52 bifurcates so as to supply the cleansing liquid to the two nozzles 54a and 54b, and includes valves 52a and 52b on the respective bifurcated lines.

To cleanse the substrate holder 30, first, the substrate holder 30 is housed into the cleansing bath body 51 by the substrate-holder conveying unit 153 illustrated in FIG. 8. Subsequently, the substrate holder 30 is cleansed by spraying the cleansing liquid onto the substrate holder 30 through the cleansing-liquid supply line 52, the valves 52a and 52b, and the nozzles 54a and 54b. Having been sprayed onto the substrate holder 30, the cleansing liquid is discharged through a discharge port 53 provided to the cleansing bath body 51. Having been cleansed, the substrate holder 30 is dried in the substrate-holder drying bath 161 illustrated in FIG. 10.

As illustrated in FIG. 10, the substrate-holder drying bath 161 includes a drying bath body 55 configured to house the substrate holder 30, a heated-air supply line 56 for supplying heated air to the substrate holder 30, and a pair of nozzles 57a and 57b configured to blow the heated air onto the substrate holder 30. The drying bath body 55 includes a cover 55a that covers around the housed substrate holder 30. This configuration reduces diffusion of the heated air blown onto the substrate holder 30, thereby efficiently drying the substrate holder 30. The nozzles 57a and 57b are provided to the drying bath body 55 while facing to each other to blow the heated air onto both surfaces of the substrate holder 30. The heated-air supply line 56 bifurcates so as to supply the heated air to the two nozzles 57a and 57b, and includes valves 56a and 56b on the bifurcated lines. The heated air may be, for example, dried air.

To dry the substrate holder 30, first, the cleansed substrate holder 30 is housed into the drying bath body 55. Subsequently, the substrate holder 30 is dried by blowing heated air onto the substrate holder 30 through the heated-air supply line 56, the valves 56a and 56b, and the nozzles 57a and 57b. Having dropped from the substrate holder 30, the cleansing liquid is discharged through a discharge port 58 provided to the drying bath body 55.

The cleaning device 50 cleanses and dries the substrate holder 30 holding no substrate. In this state, a gap is formed between the first holding member 31 and the second holding member 32. Through the gap, the cleansing liquid and heated air reach the substrate sealing member 39, the holder sealing member 42, the electric contact 44, and the relay contact portion 49 of the substrate holder 30 illustrated in FIG. 3. Accordingly, these sealing members and contact points are cleansed and dried.

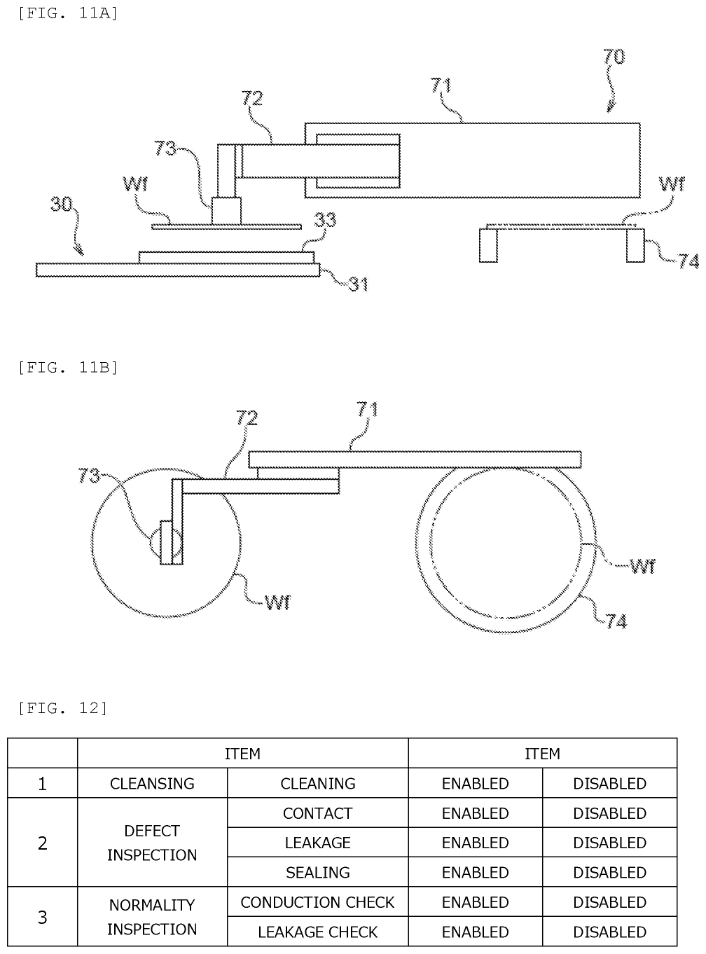

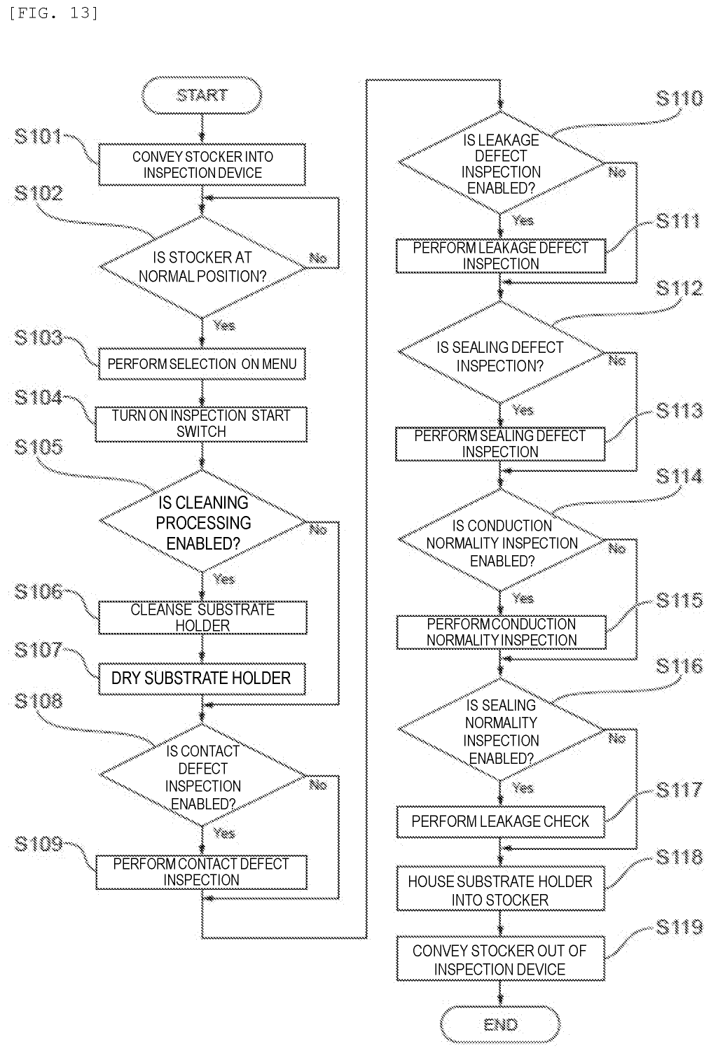

The following describes the substrate conveyance device 70 illustrated in FIG. 1. FIG. 11A is a schematic side view of the substrate conveyance device 70. FIG. 11B is a schematic top view of the substrate conveyance device 70. For the purpose of illustration, FIG. 11A illustrates the substrate holder 30. As illustrated in FIGS. 11A and 11B, the substrate conveyance device 70 includes a suction unit 73 configured to suck the substrate Wf, an arm unit 72 coupled with the suction unit 73, and an electric actuator 71 configured to horizontally move the arm unit 72. The suction unit 73 holds the substrate Wf through, for example, vacuum suction.

To transfer the substrate Wf to the substrate holder 30 by the substrate conveyance device 70, first, the substrate holder 30 is horizontally placed on the base 61 of the fixing unit 60 illustrated in FIG. 5. Subsequently, the suction unit 73 holds the substrate Wf being placed on a substrate placement table 74, and the electric actuator 71 moves the suction unit 73 holding the substrate Wf. The substrate conveyance device 70 places the substrate Wf on the placement surface 33 by canceling the suction by the suction unit 73 while the substrate Wf is positioned on the placement surface 33 of the first holding member 31 of the substrate holder 30. The substrate Wf is used to check conduction between the substrate holder 30 and the substrate Wf by the conduction check device (not illustrated) and to check leakage from the substrate holder 30 by the leakage check device (not illustrated). Thus, the substrate Wf may be a dummy substrate for conduction check and leakage check.

The conduction check device (not illustrated) checks the conduction between the substrate holder 30 and the substrate Wf while the fixing unit 60 locks the second holding member 32 to the first holding member 31 and the substrate holder 30 holds the substrate Wf. Subsequently, the leakage check device (not illustrated) checks any leakage through the substrate sealing member 39 and the holder sealing member 42 of the substrate holder 30 holding the substrate Wf. After the conduction check and leakage check, the fixing unit 60 removes the second holding member 32 from the first holding member 31, and the substrate conveyance device 70 sucks the substrate Wf and returns the substrate Wf onto the substrate placement table 74. As described above, when the conduction check device checks the conduction between the substrate holder 30 and the substrate Wf or when the leakage check device checks any leakage from the substrate holder 30, the substrate conveyance device 70 conveys the substrate Wf to the substrate holder 30.

FIG. 12 illustrates an exemplary menu screen displayed on the display unit included in the control device 90 illustrated in FIG. 1. As illustrated in FIG. 12, the screen displays three items of “cleansing”, “defect inspection”, and “normality inspection”. “Cleaning” is displayed as a specific item corresponding to “cleansing”. This item means the cleansing and drying at the cleaning device 50 illustrated in FIGS. 9 and 10. “Contact”, “leakage”, and “sealing” are displayed as specific items corresponding to “defect inspection”. “Contact” means appearance inspection of the electric contact 44, the relay contact portion 49, and the external contact portion 38 by the appearance inspection apparatus 80. “Leakage” means appearance inspection by the appearance inspection apparatus 80 on whether the plating solution flows (is leaked) into the internal space of the substrate holder 30. “Sealing” means appearance inspection of the substrate sealing member 39 and the holder sealing member 42 by the appearance inspection apparatus 80. “Conduction check” and “leakage check” are displayed as specific items corresponding to “normality inspection”. “Conduction check” means inspection by the conduction check device, and “leakage check” means inspection by the leakage check device.

“Enabled” and “disabled” are displayed on the right side in the screen for each inspection item. When the display unit of the control device 90 is a touch panel, a worker touches the display unit to select whether the inspection item is “enabled”, that is, “performed”, or is “disabled”, that is, “not performed”. Alternatively, an operation unit other than the display unit may be used to allow the selection between “enabled” and “disabled” by the worker.

The above-described inspection apparatus 20 according to the present embodiment is an independent apparatus, but the present invention is not limited thereto. The inspection apparatus 20 may be mounted on a plating apparatus configured to perform plating processing on the substrate Wf by using the substrate holder 30. In this case, each processing bath such as a plating bath provided to the plating apparatus, from which treatment solution such as plating solution has been discharged, may be used as the stocker 22 of the inspection apparatus 20. In other words, any optional case capable of housing the substrate holder 30 may be used as the stocker 22.

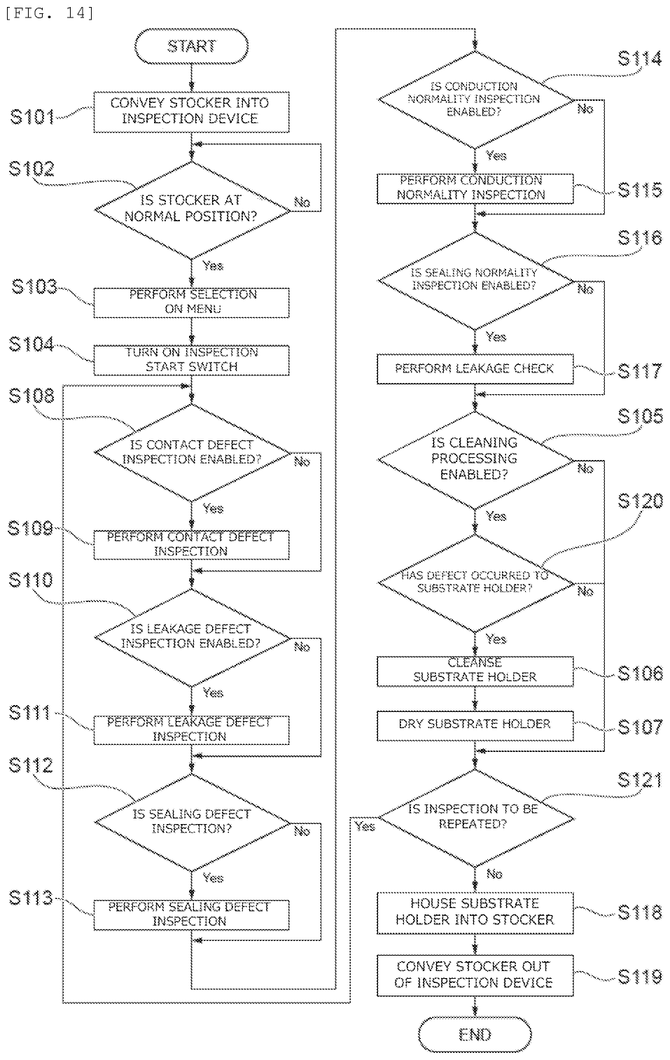

The following describes an inspection method using the inspection apparatus 20 according to the present embodiment. FIG. 13 is a flowchart illustrating an exemplary inspection method using the inspection apparatus 20 according to the present embodiment. First, to inspect the substrate holder 30 through the inspection apparatus 20, the stocker 22 housing the substrate holder 30 to be inspected is conveyed into the inspection apparatus 20 (step S101). Subsequently, the position sensor (not illustrated) of the inspection apparatus 20 detects whether the stocker 22 is at a normal position such as the stocker installation part 22a illustrated in FIG. 1 (step S102). If it is determined that the stocker 22 is at the normal position (Yes at step S102), the menu screen illustrated in FIG. 12 is displayed on the display unit of the control device 90. A worker selects “enabled” or “disabled” for inspection item on the menu screen (step S103) and turns on an inspection start switch (not illustrated) provided to the control device 90 (step S104).

Once an inspection is started, first, the control device 90 determines whether the item “cleaning” on the menu screen illustrated in FIG. 12 is enabled (step S105). If it is determined that “cleaning” is enabled (Yes at step S105), the transporter 24 takes the substrate holder 30 out of the stocker 22 and conveys the substrate holder 30 to the cleaning device 50. The cleaning device 50 cleanses the substrate holder 30 at the substrate-holder cleansing bath 160 illustrated in FIG. 9 (step S106), and dries the substrate holder 30 at the substrate-holder drying bath 161 illustrated in FIG. 10 (step S107). If it is determined that “cleaning” is disabled (No at step S105), steps S106 and S107 are skipped.

Subsequently, the control device 90 determines whether the item “contact” on the menu screen illustrated in FIG. 12 is enabled (step S108). If it is determined that “contact” is enabled (Yes at step S108), the appearance inspection apparatus 80 performs contact defect inspection (step S109). Specifically, first, the transporter 24 conveys the substrate holder 30 to the fixing unit 60. As illustrated in FIG. 5, the fixing unit 60 removes the second holding member 32 from the first holding member 31, and the appearance inspection apparatus 80 acquires image data or shape data of the electric contact 44, the relay contact portion 49, and the external contact portion 38 of the substrate holder 30. The acquisition may be performed on image data or shape data of at least one of the electric contact 44, the relay contact portion 49, and the external contact portion 38. The appearance inspection apparatus 80 compares the acquired image data or shape data with image data or shape data stored in the memory to determine whether, for example, bending, break, or corrosion occurs to the electric contact 44, the relay contact portion 49, and the external contact portion 38. A result of the determination is transmitted to the control device 90. If it is determined that “contact” is disabled (No at step S108), step S109 is skipped.

Subsequently, the control device 90 determines whether the item “leakage” on the menu screen illustrated in FIG. 12 is enabled (step S110). If it is determined that “leakage” is enabled (Yes at step S110), the appearance inspection apparatus 80 performs leakage defect inspection (step S111). Specifically, as illustrated in FIG. 5, the fixing unit 60 removes the second holding member 32 from the first holding member 31, and the appearance inspection apparatus 80 acquires image data or shape data of the inside of the substrate holder 30. The appearance inspection apparatus 80 compares the acquired image data or shape data with image data or shape data stored in the memory to determine whether the plating solution has flowed into the internal space. Whether the plating solution has flowed into the internal space can be determined based on, for example, the color of the plating solution in the acquired image data. A result of the determination is transmitted to the control device 90. If it is determined that “leakage” is disabled (No at step S110), step S111 is skipped.

Subsequently, the control device 90 determines whether the item “sealing” on the menu screen illustrated in FIG. 12 is enabled (step S112). If it is determined that “sealing” is enabled (Yes at step S112), the appearance inspection apparatus 80 performs sealing defect inspection (step S113). Specifically, as illustrated in FIG. 5, the fixing unit 60 removes the second holding member 32 from the first holding member 31, and the appearance inspection apparatus 80 acquires image data or shape data of the substrate sealing member 39 and the holder sealing member 42 of the substrate holder 30. The acquisition may be performed on image data or shape data of at least one of the substrate sealing member 39 and the holder sealing member 42. The appearance inspection apparatus 80 compares the acquired image data or shape data with image data or shape data stored in the memory to determine whether, for example, a flaw occurs to the substrate sealing member 39 and the holder sealing member 42. A result of the determination is transmitted to the control device 90. If it is determined that “sealing” is disabled (No at step S112), step S113 is skipped.

Subsequently, the control device 90 determines whether the item “conduction check” on the menu screen illustrated in FIG. 12 is enabled (step S114). If it is determined that “conduction check” is enabled (Yes at step S114), the conduction check device (not illustrated) provided to the fixing unit 60 performs conduction normality inspection (step S113). Specifically, the substrate Wf is conveyed to the substrate holder 30 by the substrate conveyance device 70 illustrated in FIGS. 11A and 11B and held by the substrate holder 30. In this state, the conduction check device checks conduction to the substrate Wf through the electric contact 44, the relay contact portion 49, and the external contact portion 38. More specifically, for example, the electric contact 44 is made contact with the substrate Wf to allow current flow through two of the contact portions 38a (refer to FIG. 3) of the external contact portion 38 and measure a wiring resistance. The measured wiring resistance is compared with a predetermined threshold. If the measured wiring resistance is larger than the threshold, it is determined that conduction is abnormal. A result of the determination is transmitted to the control device 90. If it is determined that “conduction check” is disabled (No at step S114), step S115 is skipped.

Subsequently, the control device 90 determines whether the item “leakage check” on the menu screen illustrated in FIG. 12 is enabled (step S116). If it is determined that “leakage check” is enabled (Yes at step S116), leakage check is performed (step S117). Specifically, the substrate Wf is conveyed to the substrate holder 30 by the substrate conveyance device 70 illustrated in FIGS. 11A and 11B and held by the substrate holder 30. In this state, the leakage check device (not illustrated) included in the fixing unit 60 determines whether the substrate sealing member 39 of the substrate holder 30 appropriately seals a gap between the first holding member 31 and the substrate Wf surface and the holder sealing member 42 appropriately seals between the first holding member 31 and the second holding member 32. A result of the determination is transmitted to the control device 90. If it is determined that “leakage check” is disabled (No at step S116), step S117 is skipped.

After the inspections described above, the transporter 24 houses the substrate holder 30 into the stocker 22 (step S118), the stocker 22 is conveyed out of the inspection apparatus 20. As described above, the inspections are executed on the substrate holder 30 as an inspection target in accordance with selection by the worker. According to the inspection method illustrated in FIG. 13, the control device 90 causes the cleaning device 50 to cleanse the substrate holder 30 before the inspections by the appearance inspection apparatus 80 and the leakage check device. In this manner, the substrate holder 30 as an inspection target can be cleansed once before the inspection device 20 inspects the cleansed substrate holder 30.

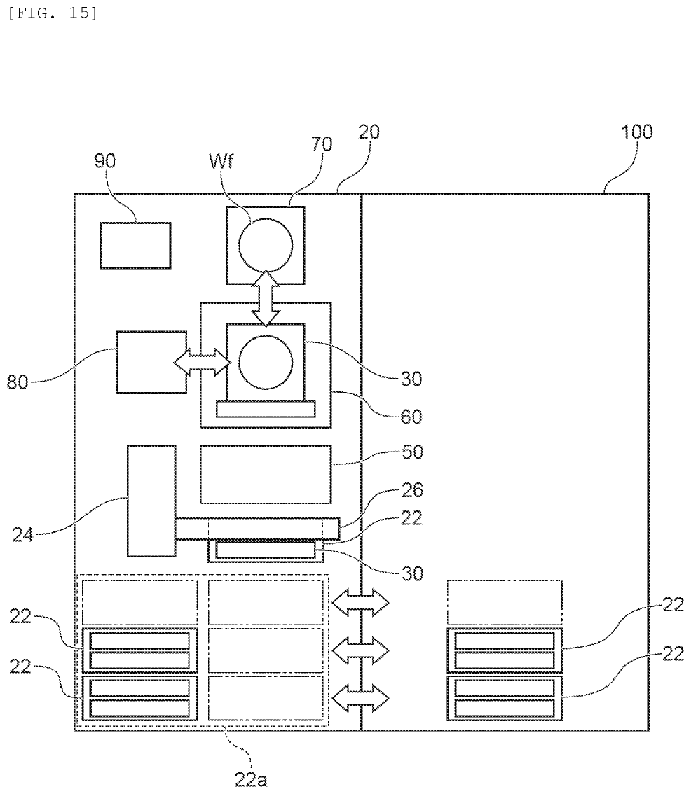

FIG. 14 is a flowchart illustrating another exemplary inspection method using the inspection apparatus 20 according to the present embodiment. The inspection method illustrated in FIG. 14 differs from the inspection method illustrated in FIG. 13 in that the cleansing (steps S105 to S107) of the substrate holder 30 by the cleaning device 50 is performed after the inspection by the appearance inspection apparatus 80, the inspection by the conduction check device, and the inspection by the leakage check device. In the process illustrated in FIG. 14, the cleansing of the substrate holder 30 is performed when a defect has occurred to the substrate holder 30.

In the inspection method illustrated in FIG. 14, if it is determined at step S116 that the item “leakage check” on the menu screen illustrated in FIG. 12 is disabled (No at step S116) or after the leakage check is performed at step S117, it is determined whether the item “cleaning” on the menu screen illustrated in FIG. 12 is enabled (step S105). If it is determined that “cleaning” is enabled (Yes at step S105), the control device 90 subsequently determines whether any inspection performed in advance has found a defect on the substrate holder 30 (step S120). If it is determined that a defect has occurred to the substrate holder 30 (Yes at step S120), the cleaning device 50 cleanses and dries the substrate holder 30 (steps S106 and S107).

If it is determined at step S105 that “cleaning” is disabled (No at step S105) or if it is determined that any inspection performed in advance has found no defect on the substrate holder 30 (No at step S120), the processing at step S106 and at step S107 is skipped.

Subsequently, the control device 90 determines whether to repeat any inspection performed in advance (step S121). Whether to repeat any inspection may be set to the control device 90 by the worker in advance. If it is determined that an inspection is to be repeated (Yes at step S121), the process returns to step S108 to repeat the inspection. If it is determined that no inspection is to be repeated (No at step S121), the substrate holder 30 is housed into the stocker 22 (step S118) and conveyed out of the inspection apparatus 20 (step S119).

As described above, according to the inspection method illustrated in FIG. 14, if it is determined that a defect has occurred to the substrate holder 30, the inspection apparatus 20 automatically cleanses the substrate holder 30. When the defect of the substrate holder 30 is attributable to contamination of the substrate holder 30, the substrate holder 30 can be made non-defective by cleansing. According to the inspection method, after cleansing the substrate holder 30 to which it is determined that a defect has occurred, the inspection apparatus 20 can inspect the substrate holder 30 again at the appearance inspection apparatus 80, the conduction check device, and the leakage check device. Accordingly, it is possible to check whether the substrate holder 30 has become non-defective by the cleansing.

### Second Embodiment

The following describes a second embodiment of the present invention with reference to the accompanying drawings. FIG. 15 is a schematic entire arrangement diagram of the inspection apparatus 20 according to the second embodiment. The inspection apparatus 20 illustrated in FIG. 15 differs from the inspection apparatus 20 illustrated in FIG. 1 mainly in that the inspection apparatus 20 illustrated in FIG. 15 is coupled with a plating apparatus 100 configured to perform plating processing on the substrate Wf by using the substrate holder 30. FIG. 15 omits illustration of a specific configuration of the plating apparatus 100. The inspection apparatus 20 according to the second embodiment includes the stocker installation part 22a configured to take in a plurality of the stockers 22. These stockers 22 are movable between the plating apparatus 100 and the inspection apparatus 20. In the present specification, the coupling between the inspection apparatus 20 and the plating apparatus 100 means coupling between a gateway of the inspection apparatus 20 for the stockers 22 and a gateway of the plating apparatus 100 for the stockers 22.

It is preferable that each stocker 22 is configured to automatically move between the plating apparatus 100 and the inspection apparatus 20. For example, the inspection apparatus 20 and the plating apparatus 100 may each include a convey roller configured to convey the stocker 22 while supporting the bottom surface thereof. Alternatively, the stocker 22 may be configured to move by itself.

To inspect the substrate holder 30 being used by the plating apparatus 100 through the inspection apparatus 20, first, the substrate holder 30 as an inspection target is housed into the stocker 22 disposed in the plating apparatus 100. The stocker 22 is then moved to the inspection apparatus 20 and interchanged with the stocker 22 disposed in the inspection apparatus 20 and housing the non-defective substrate holder 30. The latter stocker 22 is then moved to the plating apparatus 100. Accordingly, the number of substrate holders 30 usable by the plating apparatus 100 is maintained while any substrate holder 30 is being inspected by the inspection apparatus 20, thereby preventing decrease in the productivity of the plating apparatus 100.

The stocker 22 (referred to as an inspected stocker 22) housing the substrate holder 30 inspected by the inspection apparatus 20 may be stored in the inspection apparatus 20. In this case, the inspected stocker 22 may be returned to the plating apparatus 100 when another stocker 22 housing the substrate holder 30 to be inspected is conveyed out of the plating apparatus 100. Alternatively, the inspected stocker 22 may be conveyed and stored in the plating apparatus 100 when any space is available in the plating apparatus 100.

The above-described embodiments of the present invention are intended to facilitate understanding of the present invention, but not to limit the present invention. It is possible to change and modify the present invention without departing from the gist of the invention. The present invention includes an equivalent thereof. Components written in the claims and specification may be optionally combined or omitted as long as at least part of the above-described problem can be solved or at least part of the effect of the invention can be achieved.

### REFERENCE SIGNS LIST

20 inspection apparatus
22 stocker
22a stocker installation part
24 transporter
30 substrate holder
31 first holding member
32 second holding member
38 external contact portion
39 substrate sealing member
42 holder sealing member
44 electric contact
49 relay contact portion
50 cleaning device
60 fixing unit
70 substrate conveyance device
80 appearance inspection apparatus
81 measuring device
82 moving arm
90 control device
100 plating apparatus

1. An inspection apparatus that includes an electric contact configured to contact a substrate to allow current flow to the substrate and a sealing member configured to seal a surface of the substrate and that inspects a substrate holder holding the substrate, the inspection apparatus comprising:
a stocker installation part in which a stocker configured to house the substrate holder is installed;
a cleaning device configured to cleanse the substrate holder;
a substrate attaching/detaching device configured to open and close the substrate holder;
an appearance inspection apparatus configured to acquire image data or shape data of appearance of at least one of the sealing member and the electric contact; and
a conveyer configured to convey the substrate holder among the stocker, the cleaning device, and the appearance inspection apparatus.

2. The inspection apparatus according to claim 1, wherein
the substrate holder includes a first holding member including a surface on which the substrate is placed, and a second holding member including the sealing member and the electric contact and configured to detachably hold the substrate together with the first holding member,
the substrate attaching/detaching device is configured to maintain such a state that the second holding member is removed from the first holding member, and
the appearance inspection apparatus includes a measuring device configured to acquire image data or shape data of the appearance of at least one of the sealing member and the electric contact, and an arm unit configured to move the measuring device to a position between the first holding member and the second holding member.

3. The inspection apparatus according to claim 2, wherein
the second holding member of the substrate holder includes a relay contact portion configured to contact the electric contact to supply current from an external power source to the electric contact, and
the appearance inspection apparatus is configured to acquire image data or shape data of appearance of the relay contact portion.

4. The inspection apparatus according to claim 1, wherein
the substrate holder includes an external contact portion electrically connected with an external power source to supply current from the external power source to the electric contact, and
the appearance inspection apparatus is configured to acquire image data or shape data of appearance of the external contact portion.

5. The inspection apparatus according to claim 1, further comprising:
a substrate conveyance device configured to convey a dummy substrate to the substrate attaching/detaching device; and
a conduction check device configured to check conduction between the electric contact and the dummy substrate when the substrate attaching/detaching device takes in the substrate holder holding the dummy substrate.

6. The inspection apparatus according to claim 1, further comprising:
a substrate conveyance device configured to convey a dummy substrate to the substrate attaching/detaching device; and
a leakage check device configured to inspect whether the sealing member appropriately seals a surface of the dummy substrate when the substrate attaching/detaching device takes in the substrate holder holding the dummy substrate.

7. The inspection apparatus according to claim 1, further comprising a control device configured to control the conveyer, the substrate attaching/detaching device, the appearance inspection apparatus, and the cleaning device, wherein the control device causes the cleaning device to cleanse the substrate holder before inspection by the appearance inspection apparatus.

8. The inspection apparatus according to claim 1, further comprising a control device configured to control the conveyer, the substrate attaching/detaching device, the appearance inspection apparatus, and the cleaning device, wherein the control device causes the cleaning device to cleanse the substrate holder when inspection by the appearance inspection apparatus determines that the substrate holder is defective.

9. The inspection apparatus according to claim 8, wherein the control device causes the appearance inspection apparatus to inspect the substrate holder again after the inspection by the appearance inspection apparatus has determined that the substrate holder is defective and the cleaning device has cleansed the substrate holder.

10. The inspection apparatus according to claim 1, wherein
the inspection apparatus is coupled with a plating apparatus configured to perform plating processing on the substrate by using the substrate holder, and
the stocker is movable between the plating apparatus and the stocker installation part of the inspection apparatus.

11. A plating apparatus configured to perform plating processing on the substrate by using the substrate holder, the plating apparatus comprising the inspection apparatus according to claim 1,

12. An appearance inspection apparatus that includes an electric contact configured to contact a substrate to allow current flow to the substrate and a sealing member configured to seal a surface of the substrate and that inspects appearance of a substrate holder holding the substrate, the appearance inspection apparatus being configured to acquire image data or shape data of appearance of at least one of the sealing member and the electric contact and determine whether appearance of the substrate holder is non-defective.
